(19) United States
(12) Patent Application Publication
(10) Pub. No.: US 2026/0060259 A1
(43) Pub. Date: Mar. 5, 2026

(54) Assembly and Method for Pastry Shape Presentation

(71) Applicant: John Williams, Galva, KS (US)

(72) Inventor: John Williams, Galva, KS (US)

(21) Appl. No.: 19/384,910

(22) Filed: Nov. 10, 2025

(51) Int. Cl. A21D 13/47; A21D 8/06

(52) U.S. Cl. CPC A21D 13/47; A21D 8/06

(57) ABSTRACT

A pastry having an “S” spine, a center, an upper end, a lower end, a rightward end, and a leftward end; the pastry further having an arm wrapped spirally about the “S” spine's rightward end, the arm having a proximal end formed wholly with the “S” spine's upper end; the pastry further having a leg wrapped spirally about the “S” spine's leftward end, the leg having a proximal end formed wholly with the “S” spine's lower end.

### FIELD OF THE INVENTION

The instant inventive assembly and method for pastry shape presentation is related to flour dough based bakery goods. More particularly, the instant assembly and method is related to physical, geometric and/or structural configurations of bakery goods for enhancement of such goods'performance of their appealing visual appearance functions; the invention including method and process steps for creating such configurations.

### BACKGROUND OF THE INVENTION

The bakery and baked goods arts have a long history of specially configuring raw dough to enhance the visual appearance of finally baked goods, such enhancement being achieved by means of configuring of baked pastries and the like to visually present various geometric shapes and configurations.

Just as hair is often braided for enhancement of a person's appearance, raw dough strands are known to be braided prior to baking, the braided of the dough producing an appealing braided look and appearance at the surfaces of the finally baked product. Chellah bread is similarly known to include 3, 4, 5, or 6 braided dough strands for enhancement of the appearance of the finally baked product. Other baked goods physical appearance enhancing configurations, such as leaf-like fougasse breads, are known.

The instant invention similarly enhances the presentation appearance of a baked goods item or pastry by incorporating and presenting in bold relief at the item's exterior an appearance of an alphabetic letter. The instant invention importantly presents only a single and particular letter selected among the alphabet's 26 letters.

Each letter among the first, second, fourth through ninth, eleventh through fifteenth, sixteenth through eighteenth, twentieth, and twenty-second through twenty-sixth letters of the modern English alphabet includes unsightly intersecting or broken lines. While none of the letters among the third, tenth, fifteenth, and twenty-first letters of the alphabet (i.e. C, J, O, and U) includes any intersecting lines, each of those letters presents a visually unappealing and uninteresting single curve.

The letter “S” is unique among the alphabet's 26 letters, such letter both omitting any unsightly broken or intersecting lines and including a visually balanced double curve. The incorporation of an “S” figure and image within the commonly known yin-yang symbol “ [symbol] ” attests to the fact that the figure and form of the letter “S” visually portrays, balance and harmony. None of the other letters of the alphabet have such visual effect. Accordingly, the instant invention incorporates the letter “S”.

The instant invention achieves a synthesis of the bakery arts'usage of appealing geometric configurations, with the positive connotations and imagery of the letter “S” by establishing within a pastry baked good's item a bold relief presentation of the letter “S”.

### BRIEF SUMMARY OF THE INVENTION

The instant invention comprises a specially configured pastry, the term “pastry” being intended to include all types of flour based baked goods.

A first or central component of the instant inventive pastry comprises an “S” spine. A known typographic component of a capital letter “S” constitutes the letter's central spine. Central areas of the instant inventive pastry present in bold relief a similarly curved central area, and such central area of the inventive pastry is hereby denominated and defined as an “S”spine component.

The “S” spine component of the inventive pastry has a center or a central area, an upper end, and a lower end, a right side or end, a left side or end, and a height dimension “H”spanning between the “S”spine's upper and lower ends.

The instant inventive pastry further comprises an arm component having a width “W ” and having a proximal end which is fixedly attached to formed wholly with the “S” spine's upper end. In the preferred embodiment, the pastry's arm component initially extends rightwardly and arcuately curves in the clockwise direction around the “S” spine's right side.

The instant inventive pastry further comprises a leg component which is configured similarly with the arm component. In the preferred embodiment, the pastry's leg component has a proximal end which is fixedly attached to or formed wholly with the “S” spine's lower end, such leg initially extending leftwardly and arcuately curving in the clockwise direction around the left side of the “S” spine.

Similarly with the spirally extending tail portion of an “at” or “@” symbol, the arm and leg components of the instant inventive pastry spirally wrap about the pastry's central “S” spine component. The dual or double spiral wraps which is effected by the arm and leg components enhance and compliment the visually balanced double curve of which is formed by the pastry's central “S” figure.

The lengths of the pastry's arm and leg components are at least sufficient to allow a medial or distal portion of the arm component to radially underlie the lower end of the “S” spine, and to allow a medial or distal portion of the leg component to radially overlie the “S” spine's upper end. However, in a preferred embodiment, the arm and leg components have additional lengths which are at least ¾π times the pastry's diameter where the diameter is equal to the height “H” of the “S” spine plus the two times the width “W” of the arm or leg. Such at least 3/4 π (H+2W) lengths of the pastry's arm and leg components allow their distal ends to extend at least ¼ of the circumference of the pastry beyond the above-described radially underlying and radially overlying positions.

The inventive pastry is preferably initially formed by a baker upon a flat surface, suitably a baker's board. An oblongated dough strip is preliminarily formed and provided, the dough strip being placed upon the flat surface for the performance by the baker of an “S” spine creating step. In a preferred mode of performance of the invention's method, the oblongated dough strip preferably has a pliable dough consistency between medium-soft and stiff.

Thereafter, the baker may provide a two-pronged spindle tool having a gap between the prongs sufficient for a fitted receipt of the dough strip's width “W”. Upon receipt of the dough strip between the spindle's prongs the baker may turn the spindle tool counterclockwise, twisting or kinking the dough strip at its midpoint into the “S” spine shape. An initial approximate 180 degree turn of the spindle tool suitably forms the “S” spine component of the instant inventive pastry.

Thereafter, continued counterclockwise turning of the spindle tool effectively reels or winds the oppositely extending ends of the dough strip about the spindle and the “S” spine, such tool turning step effectively spirally wrapping the pastry's arm and leg components around the “S” spine's right and left sides. Thereafter, the spindle tool may be removed and the “S” presenting and spirally wrapped pastry may be baked in a conventional fashion in an oven.

In an alternate mode of performance of the method of the invention, the two-pronged spindle tool may suitably comprise a pair of fingers of the baker's hand. For example, the baker may use a grasping and twisting action of the thumb and index finger of one of his or her hands to initially form the pastry's central “S” spine component.

In an alternate mode of performance of the method of the invention, the paired prongs of the spindle tool may comprise posts or shafts which are fixedly attached to and which extend upwardly from the flat upper surface of the baker's board. Such posts are preferably adjacent and displaced away from each other the distance “W” which facilitates the fitted receipt of a middle portion of a dough strip. Thereafter, the baker may grasp in his or her left and right hands the opposite ends of the dough strip. Thereafter, the baker may orbitally move the oppositely extending ends of the dough strips clockwise, causing the pastry's “S” spine component to be initially formed within and between the posts. Thereafter, the operator may continue to orbitally move the opposite ends of the dough strip in a spirally wrapping fashion about the posts anchored “S” spine component. Following completion of spiral wraps of the dough strip's arm and leg, the raw dough pastry may be removed from the posts, and it may their be baked in an oven in a conventional fashion. The instant invention's finally baked pastry product advantageously presents in bold relief at its central area the letter “S”, such presentation having visually presentation appeal.

In an alternate mode of performance of the method of the invention, the baker may utilize fingers, as described above, to initially form the dough strip's “S” spine component. Thereafter, the baker may grasp and manually orbitally move the oppositely extending ends of the dough strip (i.e. the pastry's arm and leg components) about the formed “S” spine. Further alternatively, the initially formed “S” spine may itself be grasped and turned by the baker, such “S” spine turning action utilizing the formed “S” spine itself as a dough strip reeling or winding spindle.

Accordingly, objects of the instant invention include the provision of a pastry and method steps for making the pastry which incorporates structures as described above, which utilizes method and process steps as described above, and which arranges those structures and performs those process steps in manners described above.

Other and further objects, benefits, and advantages of the instant invention will become known to those skilled in the art upon review of the detailed description which follows, and upon review of the appended drawings.

### BRIEF DESCRIPTION OF DRAWINGS

FIG. 1 is a perspective view of a suitable embodiment of the instant inventive pastry.

FIG. 2 re-depicts the structure of FIG. 1, the view of FIG. 2 being an opposite side perspective view.

FIG. 3 is a side view of the pastry of FIG. 1.

FIG. 4 is an opposite side view of the pastry of FIG. 1.

FIG. 5 is a top view of the pastry of FIG. 1.

FIG. 6 is a bottom view of the pastry of FIG. 1.

FIG. 7 shows a pastry board, raw dough strip, and spindle tool components which are provided in performance of the instant inventive method.

FIG. 8 shows an alternate pastry board having attached spindle tines or posts, the view showing an overlying dough strip.

FIG. 9 re-depicts the structure of FIG. 8, the view showing the dough strip received between the spindle tines.

FIG. 10 shows a method step of manually orbitally moving the ends of the dough strip of FIG. 9 about the spindle.

### DETAILED DESCRIPTION OF THE INVENTION

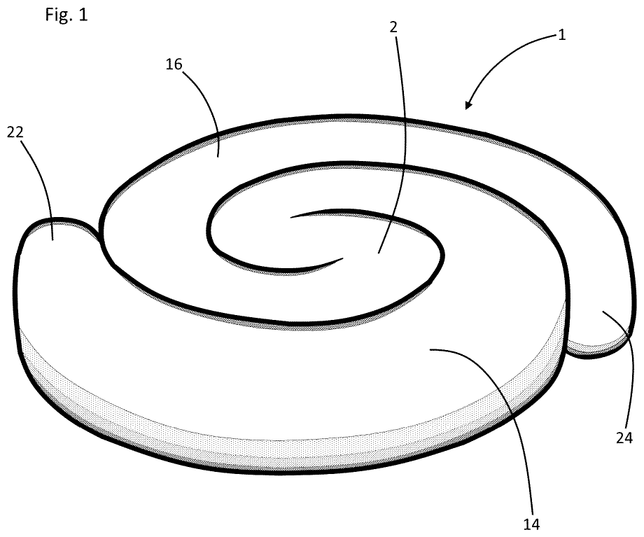

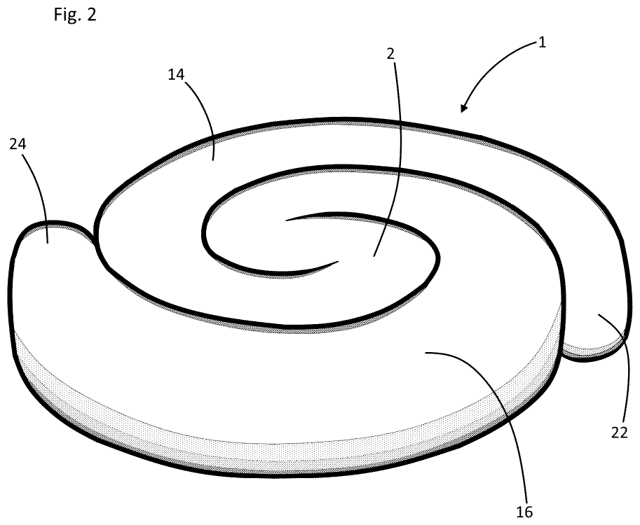

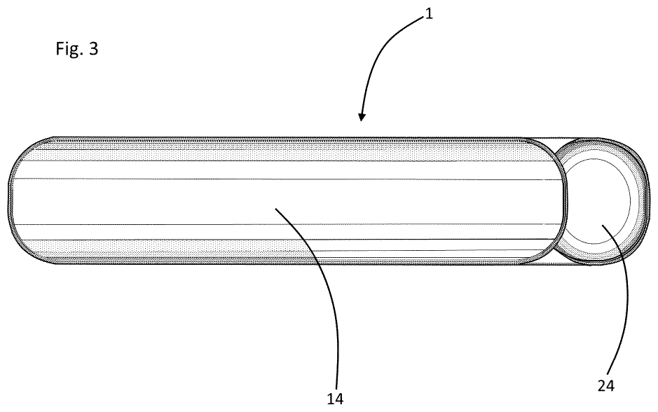

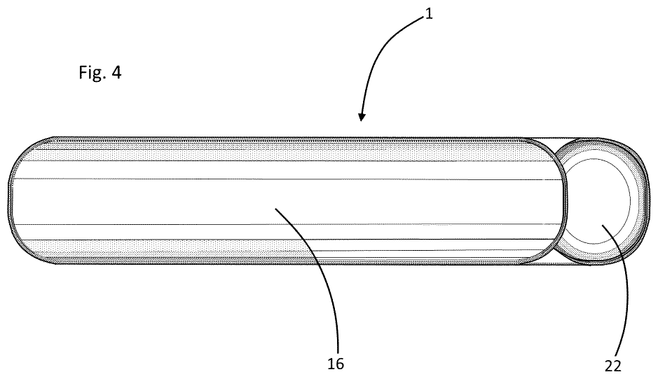

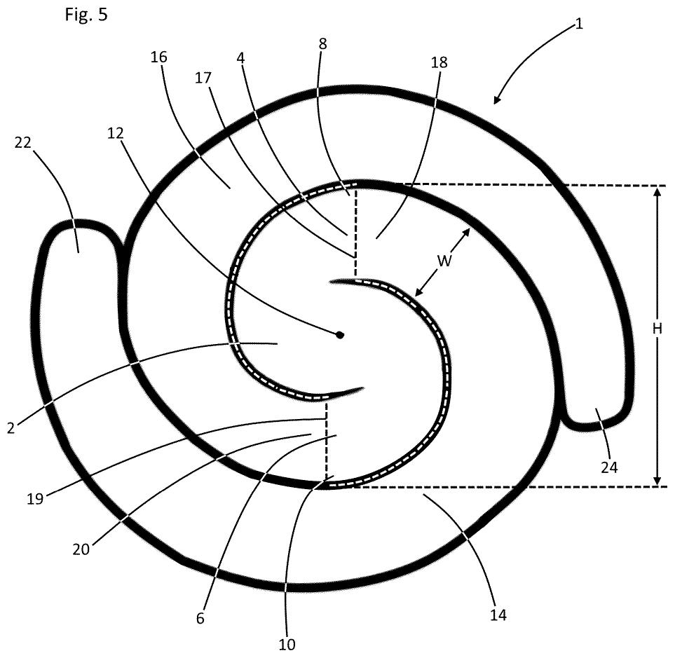

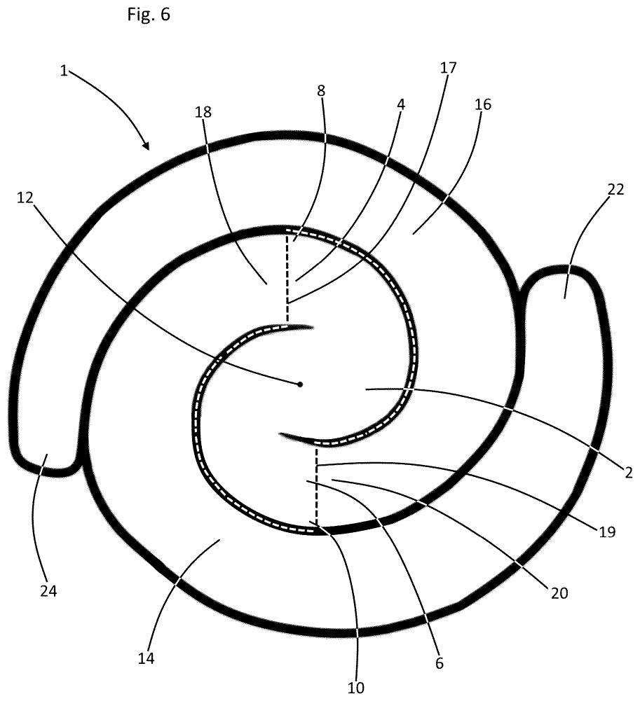

Referring now to the drawings, and in particular, simultaneously to FIG. 1-6, a suitable embodiment of the instant inventive pastry is referred to generally by reference arrow 1. The pastry 1 is composed of a flour based dough, such pastry having at its center an “S” spine component 2. Curved dashed lines drawn in FIG. 5 partially border the periphery of the “S” spine 2, such periphery being completed by arm and leg attachment designating dashed lines 17 and 19.

The “S” spine component 2 has an upper end 4 and a lower end 6, such ends 4 and 6 respectively having radially outer ends 8 and 10. The radially outer ends 8 and 10 of the “S” spine's upper and lower ends 4 and 6 are radially displaced from a center point 12 a distance equal to ½ of the height “H”of the “S”spine 2.

The pastry 1 preferably further comprises an arm 14 having a proximal end 18, the arm having an extreme distal end 22. In the preferred embodiment, the proximal end 18 of the pastry's arm 14 is either fixedly attached to or formed wholly with the upper end 4 of “S” spine 2, such whole formation or fixed attachment being denoted by the dashed line portion 17 of the “S” spine's periphery. The arm 14 extends and spirally curves in the clockwise direction from the proximal end connection 17, such extension spirally wrapping a proximal portion of the arm 14 about the right side of the “S”spine 2.

The pastry 1 further comprises a leg component 16 which has a proximal end 20 and has an extreme distal end 24. The proximal end 20 of the leg 16 is preferably fixedly attached to or formed wholly with the lower end 6 of the “S” spine 2, such attachment being represented by dashed line “S” spine periphery 19. Similarly with the clockwise spiral extension of the arm 14 about the rightward aspect of the “S” spine 2, proximal portions of the leg component 16 leftwardly extend and curve clockwise about the leftward side or aspect of the “S” spine 2.

In a suitable embodiment, the length dimensions of the pastry's arm and leg components 14 and 16 are at least sufficient to allow their distal or medial portions to respectively radially underlie and overlie outer ends 10 and 8 of the “S” spine's lower and upper ends 6 and 4. However, the arm and leg components preferably have length dimensions which allow their extreme distal ends 22 and 24 to additionally extend distances at least as great as ¼ of the pastry's outer circumference. Accordingly, in the preferred embodiment, the lengths of the arm and leg components 14 and 16 are at least 3/4 π (H+2W), where “H” is the height of the “S” spine 2, and where “W” is the width of the dough strip. Such lengths of the pastry's appendages advantageously allow the arm and leg components 14 and 16 to complete spiral wraps around at least ¾ of the pastry's circumference.

Upon conventional baking of the pastry 1, the central “S” spine 2 along with the pastry's spirally wrapped arm and leg components 14 and 16 remain visible, advantageously and appealingly presenting at its center a bold relief “S” figure. The spirally wrapped arm and leg components of the “S” figure lend additionally visual appeal to the pastry 1.

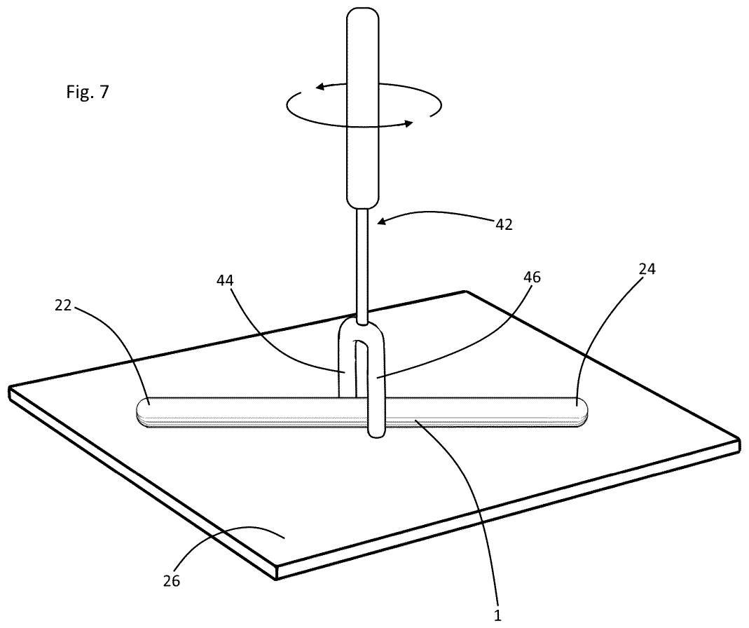

Referring to FIG. 7, a baker who fabricates the inventive pastry of FIG. 1-6, may initially provide a baker's board 26. Thereafter, the baker may place the initially elongated dough strip 1 having oppositely extending ends 22 and 24 upon the board's upper flat surface. Thereafter, the baker may provide a spindle tool 42 having a pair of prongs or tines 44 and 46, such tines being spaced apart a fitted distance which allows receipt of the width “W” of the dough strip. Thereafter, the baker may turn the tool 42 in the counterclockwise direction as shown by arrows drawn upon FIG. 7. Such turning of the tool 42 initially bends the dough strip to form the pastry's central “S” spine component 2. Further counterclockwise turning of the tool 42 progressively wraps the oppositely extending ends of the dough strip 1 to form the uncooked pastry of FIG. 5. Following such pastry formation, the baker may remove the tool 42 from the spirally formed and “S”. Thereafter, the raw pastry may be baked in an oven in a conventional fashion.

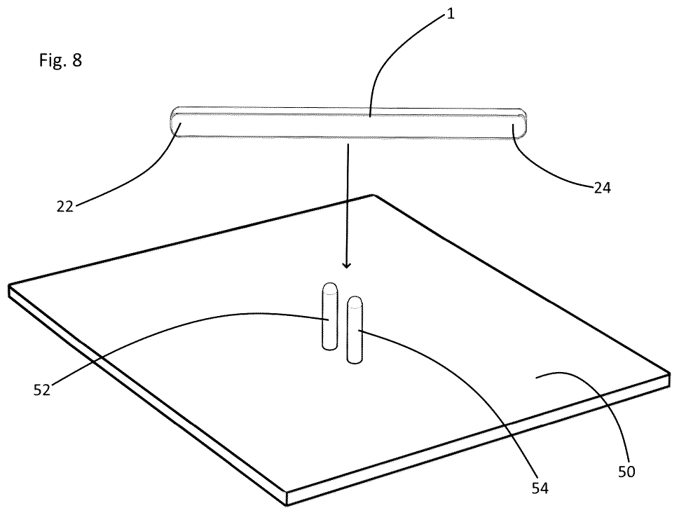

Referring to FIG. 8, in an alternate mode of performance of the instant invention, an alternate baker's board 50 may be provided, such board incorporating a differently configured spindle tool in the form of fixedly attached and upwardly extending posts or columns 52 and 54. Similarly with FIG. 7's fork tines 44 and 46, the posts 52 and 54 are spaced apart the distance W which is fitted for a similar receipt of the dough strip 1.

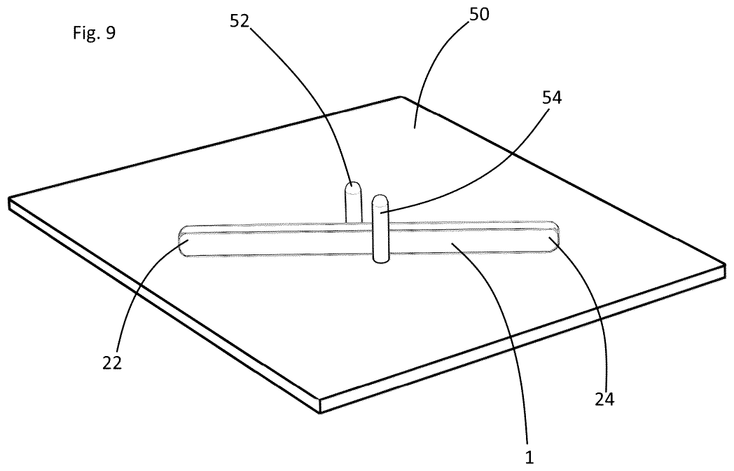

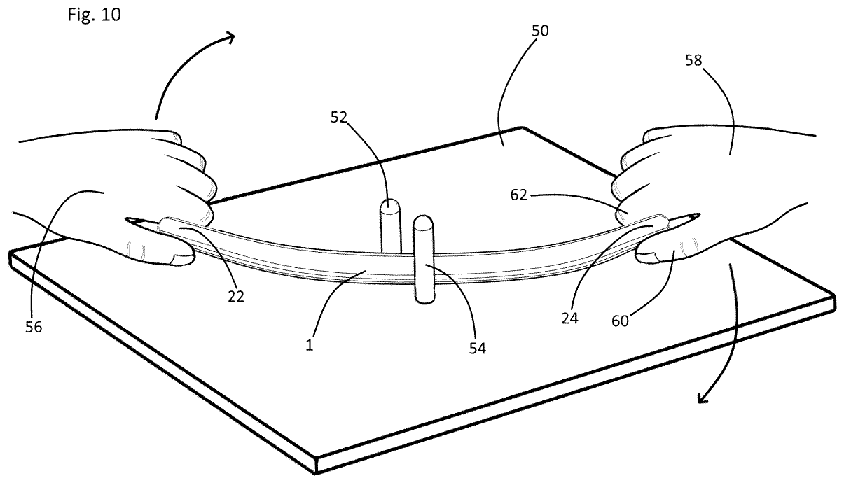

Referring to FIG. 10, following receipt of the dough strip 1 between the posts 52 and 54 as shown in FIG. 9, the baker may grasp the opposite ends 22 and 24 of the dough strip 1 in his or her left and right hands 56 and 58. Thereafter, the baker may move the opposite ends of the dough strip 1 in clockwise directions as shown by arrows drawn upon FIG. 10. Manually guided orbiting motions of the ends 22 and 24 of the dough strip 1 about the board anchored spindle 52 and 54 may effectively alternatively form the pastry of FIG. 5.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A pastry comprising:
a. An “S” spine having a height “H”, an upper end, a lower end, a rightward end, and a leftward end, wherein the “S” spine's upper and lower ends have radially outer ends, and wherein the “S” spine's height “H” is equal to the distance between said radially outer ends;
b. An arm having a width “W”, the arm being wrapped spirally about the “S” spine's rightward end, the arm having a proximal end formed wholly with the “S” spine's upper end; and
c. A leg having a width “W”, the leg being wrapped spirally about the “S” spine's leftward end, the leg having a proximal end formed wholly with the “S” spine's lower end.

2. The pastry of claim 1, wherein the “S” spine, the arm, and the leg are composed of flour.

3. The pastry of claim 2 wherein a portion of the arm radially underlies the “S” spine's lower end.

4. The pastry of claim 3 wherein a portion of the leg radially overlies the “S” spine's upper end.

5. The pastry of claim 4 wherein the arm has a distal end, the arm having a length extending from its proximal end to its distal end.

6. The pastry of claim 5 wherein the leg has a distal end, the leg having a length extending from its proximal end to its distal end.

7. The pastry of claim 6 wherein the arm's length is at least 3/4 π (H+2W).

8. The pastry of claim 7, wherein the leg's length is at least 3/4 π (H+2W).

9. A pastry making method comprising steps of:
a. Providing a flat surface;
b. Providing a two-pronged spindle;
c. Providing a dough strip having a pair of ends;
d. Placing the dough strip upon the flat surface and extending the dough strip between the spindle's prongs;
e. Rotating the spindle to reel the dough strip's ends toward the spindle;
f. Removing the spindle from the dough strip; and
g. Baking the dough strip.

10. The pastry making method of claim 9, wherein the provided two-pronged spindle is selected from the group consisting of fork tines and fingers.

11. The pastry making method of claim 10, wherein the rotation of the spindle forms a central “S” spine within the dough strip.

12. The pastry making method of claim 11, wherein one of the dough strip's ends comprises an “S” arm, and wherein the dough strip's other end comprises an “S” leg.

13. The pastry making method of claim 12, wherein the rotation of the spindle respectively spirally wraps the “S” arm and the “S” leg about right and left sides of the “S” spine.

14. A pastry making method comprising steps of:
a. Providing a flat surface;
b. Providing a two-pronged spindle, said spindle being attached to and extending upwardly from the flat surface;
c. Providing a dough strip having a pair of ends;
d. Placing the dough strip upon the flat surface and between the spindle's prongs;
e. Orbitally moving the dough strip's ends around the two-pronged spindle;
f. Removing the dough strip from the two-pronged spindle; and
g. Baking the dough strip.

15. The pastry making method of claim 14, wherein the orbital movements of the dough strip's ends form an “S” spine within the dough strip.

16. The pastry making method of claim 15, wherein one of the dough strip's ends comprises an “S” arm, and wherein the dough strip's other end comprises an “S” leg.

17. The pastry making method of claim 16, wherein the orbiting movements of the dough strip's ends respectively spirally wrap the “S” arm and the “S” leg about right and left sides of the “S” spine.
